(19) United States
(12) Patent Application Publication
(10) Pub. No.: US 2012/0085195 A1
(43) Pub. Date: Apr. 12, 2012

(54) METHOD FOR MANUFACTURING HYBRID LEVERS AND PEDALS AND IMPLEMENTATION THEREOF IN AUTOMOBILES

(75) Inventors: Eric Denis, Trigny (FR); Xavier Becue, Aumenancourt (FR); Olivier Rousseaux, Prix les Mezieres (FR); Loïc Lefebvre, Betheny (FR)

(73) Assignee: TRELLEBORG REIMS SAS, Witry les Reims (FR)

(21) Appl. No.: 13/378,304

(22) PCT Filed: Jun. 15, 2009
(86) PCT No.: PCT/FR2009/000712

§ 371 Date: Dec. 14, 2011

(51) Int. Cl. G05G 1/30; G05G 1/50; B29C 45/14; G05G 1/46

(52) U.S. Cl. 74/512; 264/219

(57) ABSTRACT

The invention relates to a method, which includes molding a metal insert from a casting by injection assisted by a fluid under pressure in concave space, forming the insert. The method including the step of restricting the space if necessary, in order to obtain a transverse cavity reducing the mass of the unit.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The invention relates to a method for making lighter levers and pedals, while preserving their original rigidity, and its application to the car industry, namely for manufacturing pedals and levers.

For some time already the car industry has been worrying about mass gains in all components of a motor vehicle by widely using plastics for the non-working parts, but this worry now reaches the working parts, to the extent that their original mechanical features can be preserved; even for elements highly strained during the use of the vehicles, such as for example the footbrake pedals, which are still widely made out of metal, whether they are direct-transmission pedals with hooking-on of the control rod (brake booster type), or offset-transmission pedals, although a hybrid solution has already appeared on the market, since it is of course necessary that the rigidity achieved by this solution remains identical to that of the fully metallic solution.

This is generally the association of a metal insert and a fiberglass-reinforced plastic material, which uses the well-known method of molding an insert from a casting ensuring the rigidity, without the molded plastic material contributing much to same.

2. Description of Related Art Including Information Disclosed Under 37 CFR 1.97 and 37 CFR 1.98.

From the French patents 2 791 297 and 2 803 241 are already known a method and a technology for manufacturing mixed items comprising a rigid element having a generally elongated shape at least one portion of which has a cross-section with a profile defining a concave space, combined with a portion made out of thermoplastic material positioned in said concave space of the rigid element, comprising at least a cavity in its cross-section. The method used consists in arranging the rigid element in an injection mold having a suitable shape, in injecting the molten thermoplastic material into the mold, and in injecting simultaneously a liquid or gaseous fluid by means of a needle into said material present in the concave space of the rigid element, by using a method for injection assisted by a liquid or gaseous fluid under pressure, commonly referred to by the specialists in the art by its English names W.I.T. (Water Injection Technology) or G.I.T. (Gas Injection Technology). One understands that using this method, after solidification of the plastic material, the latter has a transverse cavity reducing its mass, without considerably reducing its transverse inertia and, hence, its rigidity. The rigid element and the portions made out of thermoplastic material being made integral by overflow of the thermoplastic material through openings pierced into the rigid element.

U.S. Pat. No. 5,788,917 discloses a method for manufacturing a speed-gear box lever, with a steel insert, a plastic material cladding molded from a casting, and a cavity inside the plastic material, obtained by injection of a fluid during the molding from a casting, whereby this cavity can serve for the passing through of electric cables.

DE 10229921 describes a footbrake pedal associating a metal insert and an addition of plastic material permitting to place ribs more easily and at a lower cost, compared to a completely metallic part.

EP 1 331150 also discloses a footbrake pedal associating a metal insert and an addition of plastic material.

DE 102005004997 discloses a footbrake pedal entirely made out of plastic material, with a cavity obtained by injection of fluid during the injection molding, in order to avoid the expensive and complex implementation of cores.

The solutions disclosed in these three documents permit to obtain mechanical features with reduced weight and production cost, but this reduction remains limited, and there is a need for further reducing the weight and production cost of footbrake pedals, while preserving their mechanical characteristics.

One also knows, from the article published under the title <<Kunststoff-Metall-Hybride Moglichkeiten zur Herstellung von Strukturbauteilen>> in the publication <<Kunststoffe>> (edition September 2001, pages 112 to 118), a method for manufacturing front faces for the car industry using the association of a metal insert and a plastic material by molding said insert from a casting, by injection assisted by a fluid under pressure, obtaining a transverse cavity reducing the mass of the unit, but this article does not provide any solution for pedals or levers.

### SUMMARY OF THE INVENTION

To this end, the invention relates to a footbrake pedal, in particular for motor vehicles, including a metal insert having a sufficient side concavity for being suitable for molding a body of plastic material from the casting with injection of a fluid, creating a sufficient transverse cavity in the plastic material to reduce its mass without degrading the rigidity of the unit, said insert including at least a wing and a base, and in said wing, openings for the passing through of a hinging axis and a transmission axis of the pedal and, in said base, openings for making integral the body made out of plastic material molded from the casting with the metal insert. This footbrake pedal is particular in that said body includes a footbrake shoe, which includes an opening configured for the injection of said fluid during the molding from a casting,

According to further features:
said metal insert can be U-shaped
said metal insert can include a L-shaped portion
the portion located at the level of said L-shaped portion can include a cage support of the brake-rod knee joint, and be made out of plastic material molded from a casting and reinforced by ribs made out of plastic material
the hollow portion obtained by fluid injection, located in the portion of the pedal closest to the L-shaped portion, can be reinforced by ribs
said pedal can be with offset transmission with hooking-on of the control rod, and said insert manufactured in two U-shaped parts and each including a L-shaped portion for the encasement of these parts into each other, in order to obtain a common profile having a larger width, aimed at receiving, during the molding from a casting, a hinging casing extending towards the free end of the U-shaped portion, in order to form a cage support of the brake-rod knee joint.
the portions formed by the metal insert can be rigidified by ribs of plastic material.

The invention also relates to a method for manufacturing a pedal, such as a footbrake pedal for motor vehicles, including the following steps:
manufacturing a metal insert having a sufficient side concavity for being suitable for molding plastic material from the casting with injection of a fluid, thus creating a sufficient transverse cavity in the plastic material to reduce its mass without degrading the rigidity of the unit,
manufacturing a mold for injecting under pressure the chosen thermoplastic material, permitting to mold the corresponding metal insert from a casting,
injecting the plastic material into the mold and injecting the chosen fluid, by means of a needle, through the opening initially provided for this purpose, then removing from the mold after cooling.

The advantages achieved thanks to this invention consist, besides the important mass gain, in that all the functional elements of the unit are obtained in one single operation: footrest sole, pedal contactor support, passage for the axis of the pedal, control-rod hooking-on area, etc.

Further features and advantages will become clear from the following description of various embodiments of hybrid car brake pedals through molding a metal insert from a casting by injection of plastic material assisted by water under pressure according to the invention, given by way of non-restrictive examples, with reference to the attached drawings.

### BRIEF DESCRIPTION OF THE DRAWINGS

FIG. 1 represents a global, perspective side view of a direct-transmission brake pedal with hooking-on of the control rod, with indication in “grey ” of the apparent portions of the molding from a casting.

FIG. 2 represents a global, perspective side view of a offset-transmission brake pedal with hooking-on of the control rod.

FIG. 3 represents a perspective side view of the metal insert of the pedal according to FIG. 2.

FIG. 4 represents a perspective side view of the body made out of plastic material of the pedal according to FIG. 2.

FIG. 5 represents a partial perspective side view, by transparency, of the L-shaped metal insert according to FIG. 2.

FIG. 6 represents a partial perspective view from above, by transparency, of the L-shaped metal insert according to FIG. 2.

FIG. 7 represents a partial perspective view from above, by transparency, of the shoe of plastic material of the pedal according to FIG. 2.

FIG. 8 represents a global, partial and perspective view from above of the pedal according to FIG. 2.

FIG. 9 represents a perspective view by transparency of the interior of the injection channel of a single-channel pedal with L-shaped bend molded from a casting according to FIGS. 3, 5, 6, 7 and 8.

FIG. 10 represents a global, perspective, side view of a pedal with double insert molded from a casting with water injection.

FIG. 11 represents a global perspective view of the pedal with a double insert according to FIG. 10.

FIG. 12 represents a global perspective view of the portion of plastic material of the pedal according to FIG. 10.

FIG. 13 represents a partial side view of the function of the two inserts according to FIG. 10.

FIG. 14 represents a partial side view of the area of molding from a casting of the support of the brake-rod knee-joint cage of the pedal with double insert according to FIG. 10.

FIG. 15 represents a partial sectional view from below, by transparency, of the pedal according to FIG. 10, showing the water-injection opening and the limitation, according to AA, of the water-injection area.

### DETAILED DESCRIPTION OF THE DRAWINGS

When examining now more in detail all the figures, one observes:

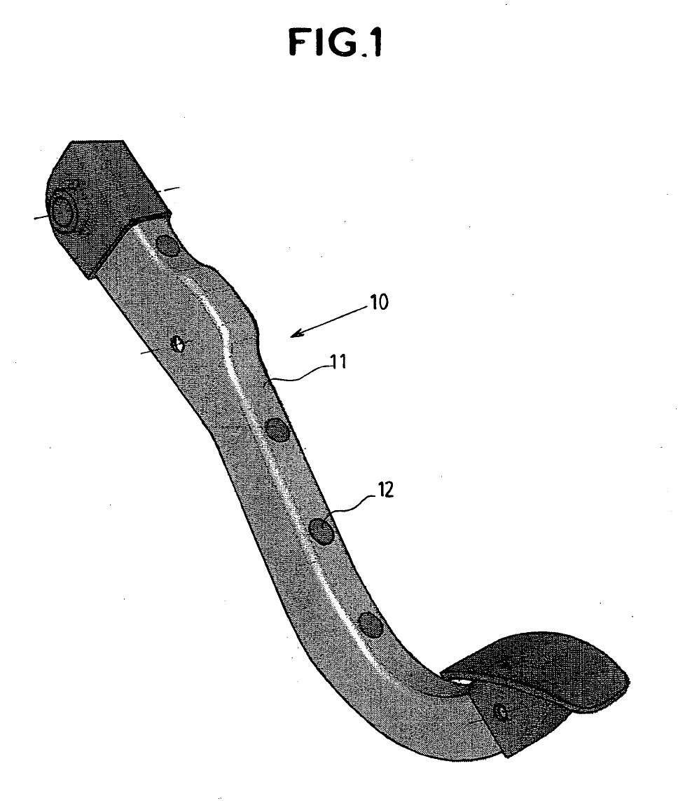

In FIG. 1, this direct-transmission pedal 10 includes a U-shaped insert 11 having an adequate shape, including, in its wings, the openings for the passing through of the hinging and transmission axis of the pedal 10, and, in its base, the openings for making the body of plastic material 12 integral with the insert 11 during the molding from a casting.

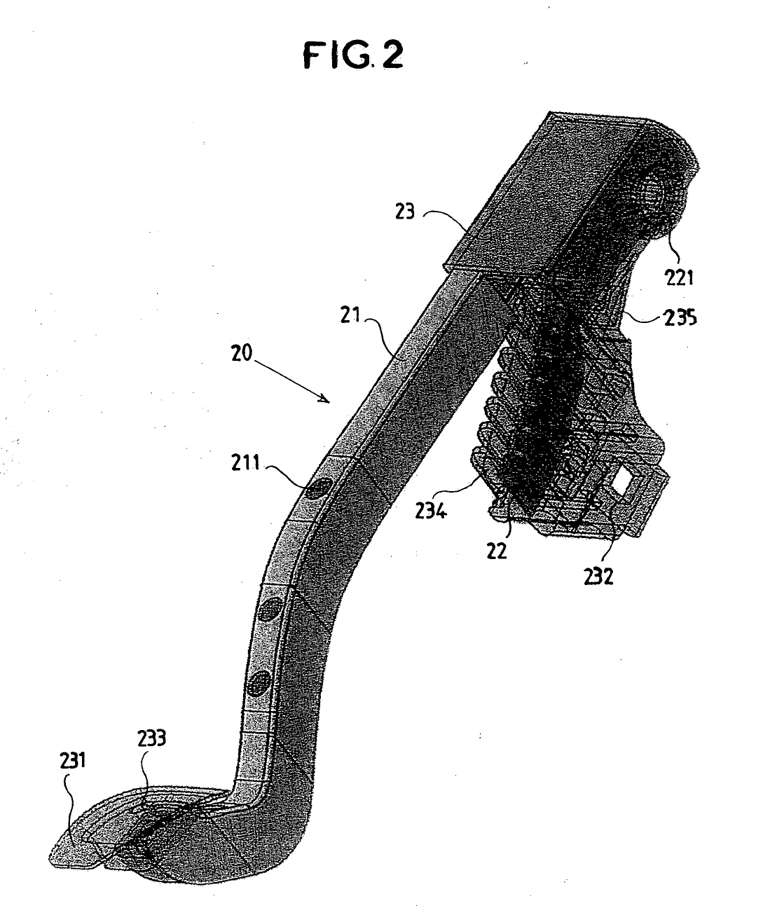

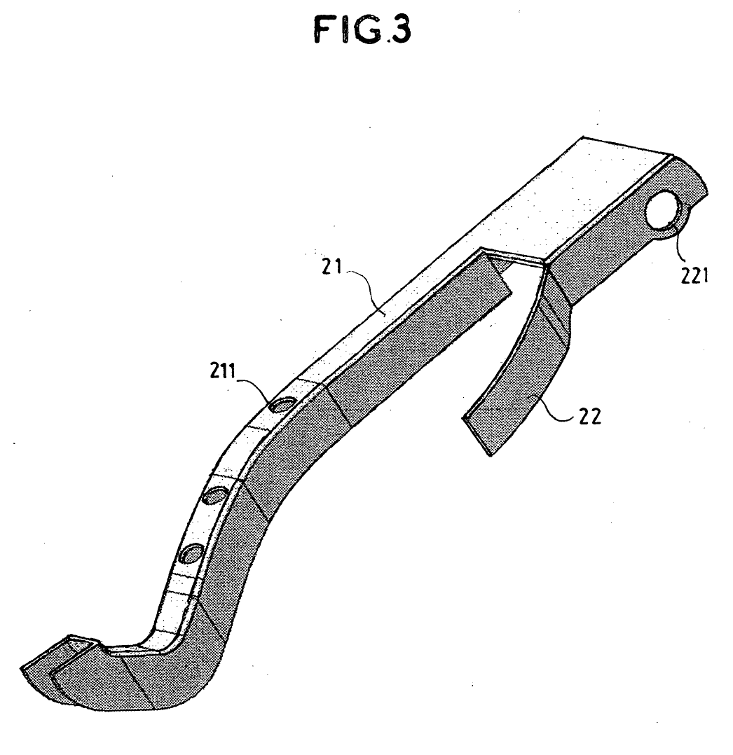

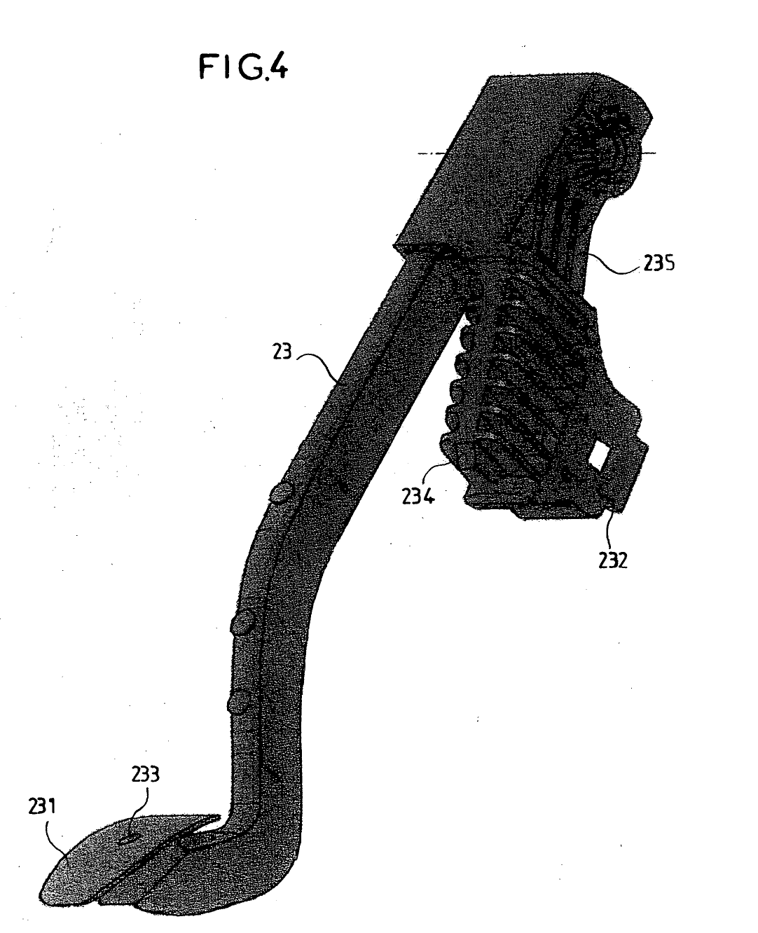

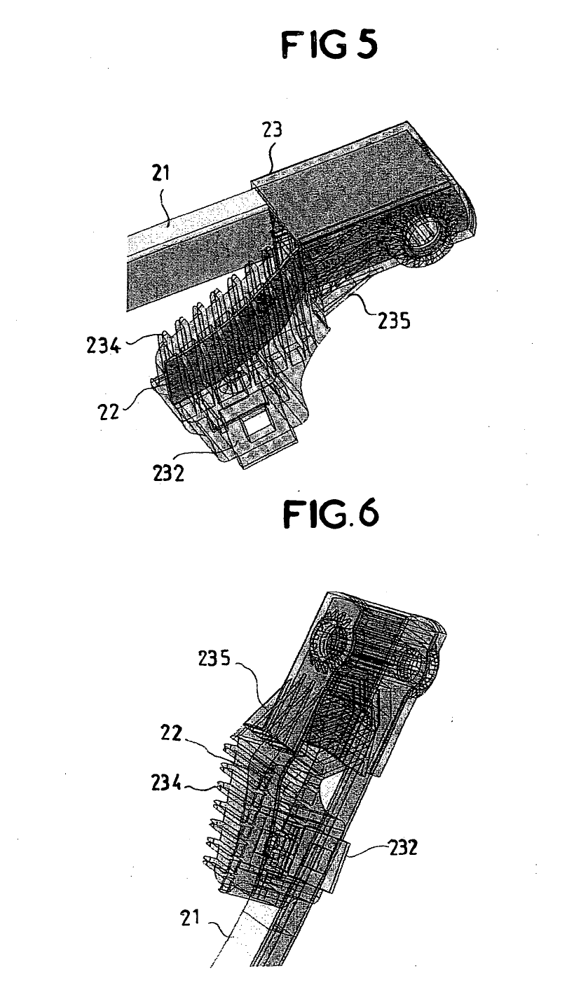

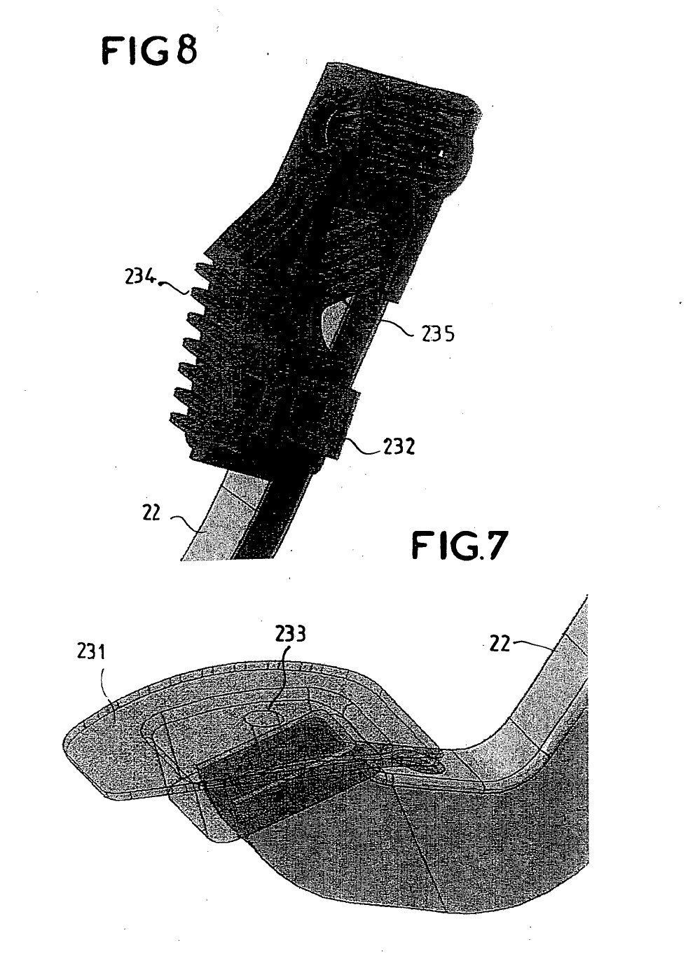

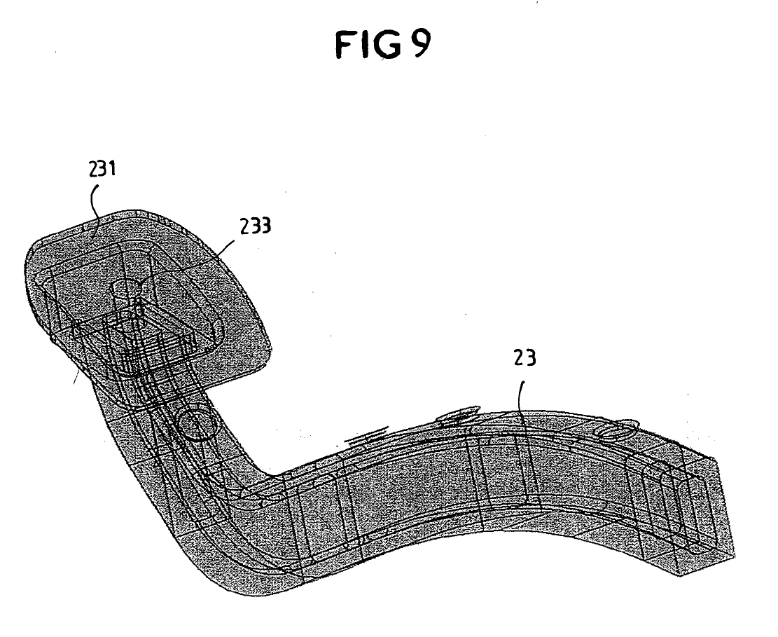

In FIGS. 2 to 9, corresponding to the hybrid offset-transmission pedal with hooking-on of the control rod, said pedal 20 comprises a U-shaped insert 21, with a side bend through a L-shaped portion 22 including, in the U-shaped portion 21 and in the base of the U, several openings 211 for making said insert 21 integral with the body of plastic material 23 during its molding from a casting and, at its end opposite the shoe 231 of the pedal 20, as well as in the L-shaped portion 22, the openings 221 for the passing through of the hinging axis of the pedal 20. The body of plastic material 23 including, as shown in FIG. 4, the shoe 231 and the offset transmission device 232.

As shown in said FIGS. 2 to 9, openings provided for in the U-shaped insert 21 ensure the retaining of the body made out of plastic material 23 in the U-shaped core; the shoe made out of plastic material 231, molded from the casting during the injection, has an opening 233 permitting the passing through of water, which pushes, through injection, the plastic material against the wings of the U. As shown in particular in FIGS. 5, 6 and 8, the portion located at the level of the L-shaped bend 22 of the metal insert 21 can be molded from the casting and also reinforced by ribs made out of plastic material 234, both on the inner and the outer side of the L-shaped portion 22 of the insert 21. The support of the cage of the brake-rod knee joint is also molded from the casting on the L-shaped portion 22 of the metal insert 21. As shown in FIG. 8, it is perfectly possible to finish the hollow portion, due to the water injection in the upper portion of the pedal 20, and to reinforce this very upper portion by adding ribs 235.

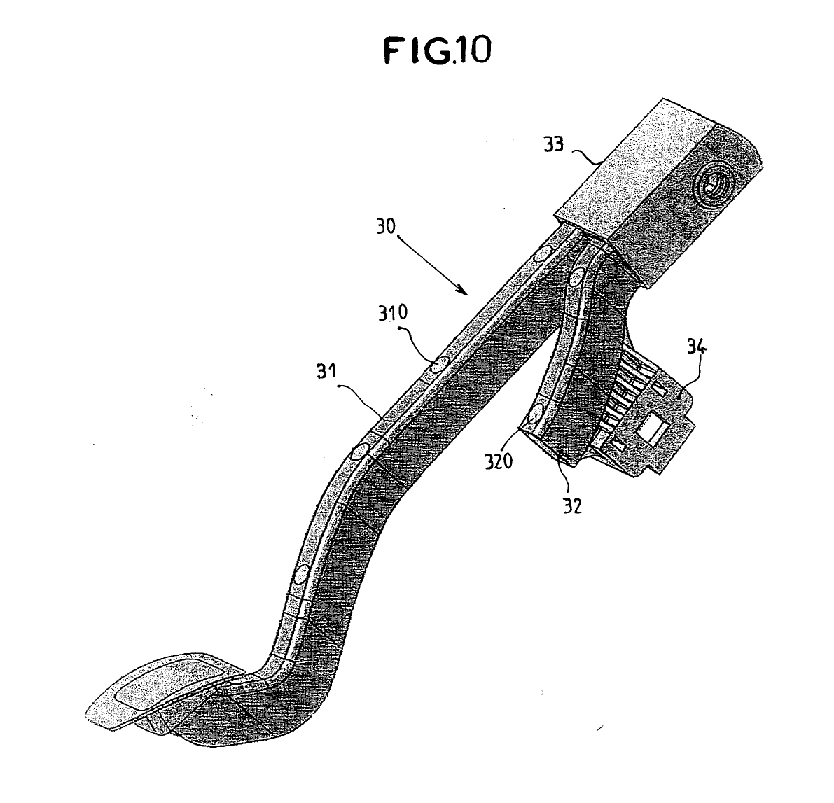

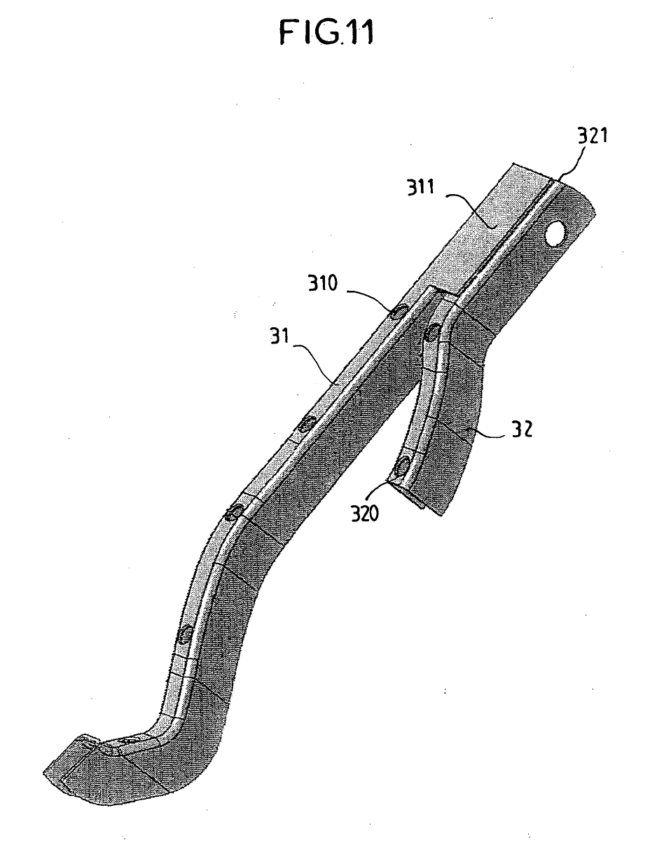

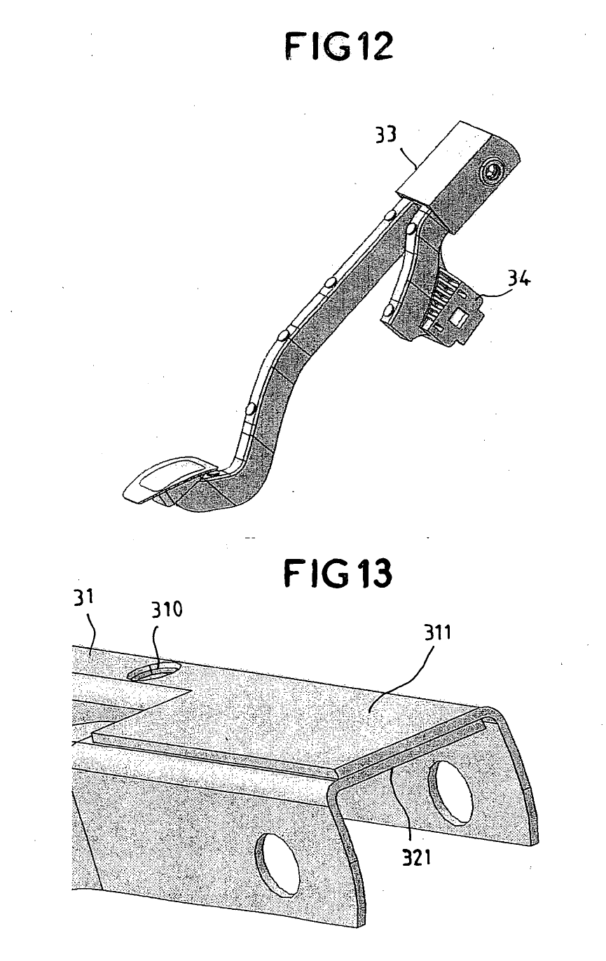

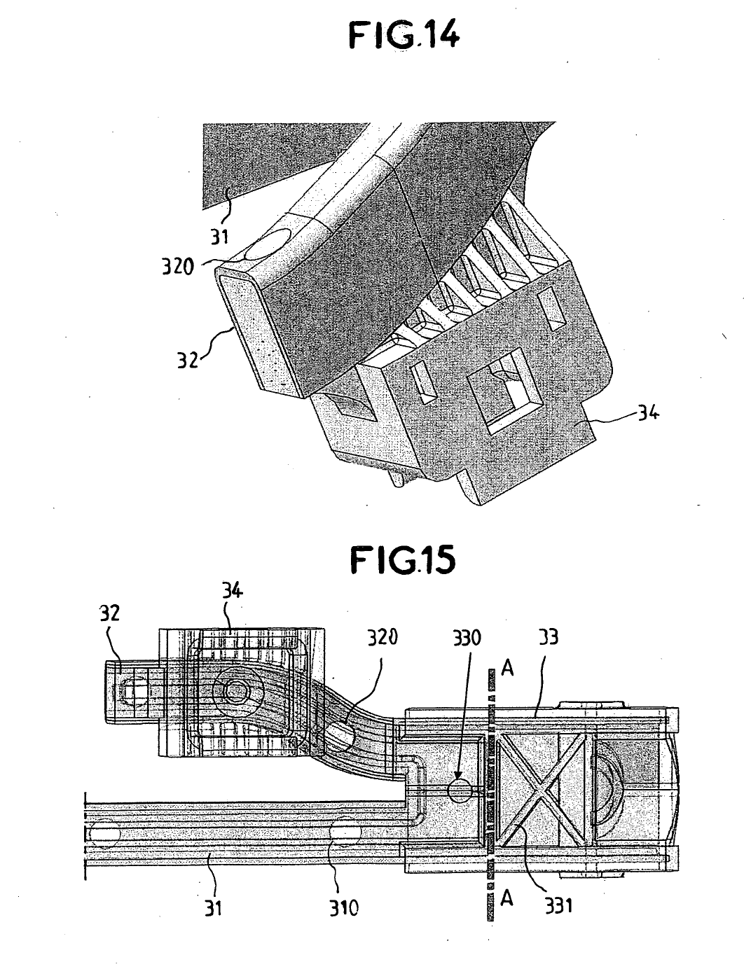

In FIGS. 10 to 15, corresponding to the hybrid offset-transmission pedal with hooking-on of the control rod, with U-shaped double insert, one observes that the insert is formed of two U-shaped parts 31 and 32, each including, at their upper end, on the side of the hinging axis, a L-shaped portion 311, 321 for encasing these parts into each other, in order to obtain a U-shaped profile through welding at the level of their overlapping area, aimed at receiving, during the molding from the casting, a hinging casing 33 extending towards the free end of the small-shaped part 32, in order to form the support of the cage of the brake-rod knee joint 34, as shown in FIG. 12. As shown in FIGS. 14 and 15, the U-shaped parts 31 and 32 forming the metal insert can be rigidified by ribs made out of plastic material, both at the outer and the inner side of these parts.

As for the simple pedal 10 of FIG. 1, the metal insert 31, 32 is provided with holes 310, 320 aimed at making the metal portion integral with the portion molded from the casting.

As represented in FIG. 15, the water injection, permitting to push the plastic material inside the space that is left to this end, occurs at one single point 330, common to both channels.

One observes, still in FIG. 15, that it is possible to finish the water-injection area at the level of the junction plane AA of both U-shaped parts 31 and 32 of the insert, by afterwards reinforcing the part by adding ribs 331, after the limit AA of the water-injection area.

In the examples given have only been used inserts with U- and L-shaped profile, but it is obvious that inserts with other profiles, such as for example T-shaped profiles, can also be used, provided only that they have a sufficient side concavity for being suitable to be molded from the casting with water injection, thus creating a sufficient transverse cavity in the plastic material to reduce its mass without degrading the rigidity of the unit.

1-6. (canceled)

7. A footbrake pedal, in particular for motor vehicles, comprising:
a metal insert having a sufficient side concavity for being suitable for molding a body comprised of plastic material from a casting with injection of a fluid, wherein a sufficient transverse cavity in the plastic material reduces mass without degrading rigidity, said metal insert comprising:
a wing, having openings for passing through a hinging axis and a transmission axis; and
a base, having openings for making integral the body,
wherein the body is comprised of a footbrake shoe, said footbrake shoe having an opening configured for injection of said fluid during the molding from a casting.

8. The footbrake pedal according to claim 7, wherein said metal insert is U-shaped.

9. The footbrake pedal, according to claim 8, having an offset transmission, wherein said metal insert comprises a L-shaped portion.

10. The footbrake pedal, according to claim 9, wherein a portion located at a level of said L-shaped portion comprises a cage support of the a brake-rod knee joint, and being comprised of plastic material molded from a casting and reinforced by ribs of plastic material.

11. The footbrake pedal, according to claim 9, wherein a hollow portion obtained by fluid injection, located in the portion of the pedal closest to the L-shaped portion, is reinforced by ribs.

12. The footbrake pedal, according to claim 9, with offset transmission and with hooking-on of a control rod, wherein said insert manufactured in two U-shaped parts, each part comprising an L-shaped portion for encasement of the parts into each other, in order to obtain a common profile having a larger width, aimed at receiving, during the molding from a casting, a hinging casing extending towards the free end of the U-shaped portion, in order to form a cage support of the brake-rod knee joint.

13. The footbrake pedal according to claim 12, wherein portions formed by the metal insert are rigidified by ribs of plastic material.

14. Method for manufacturing a pedal for a motor vehicle, according to claim 7, the method comprising the steps of:
manufacturing a metal insert having a sufficient side concavity for being suitable for molding plastic material from the casting with injection of a fluid, creating a sufficient transverse cavity in the plastic material to reduce mass without degrading rigidity;
manufacturing a mold for injecting under pressure a chosen thermoplastic material, permitting to mold the corresponding metal insert from a casting; and
injecting plastic material into the mold and injecting the chosen material by a needle, through an opening initially provided, then removing from the mold after cooling.
